(19) United States
(12) Patent Application Publication
(10) Pub. No.: US 2025/0106023 A1
(43) Pub. Date: Mar. 27, 2025

(54) SYSTEMS AND METHODS FOR TAMPER DETECTION

(71) Applicant: ROCKWELL AUTOMATION TECHNOLOGIES, INC., Mayfield Heights, OH (US)

(72) Inventors: Scott T. Griffiths, Milwaukee, WI (US); David D. Brandt, New Berlin, WI (US); Michael D. Cook, Mequon, WI (US)

(21) Appl. No.: 18/473,669

(22) Filed: Sep. 25, 2023

(51) Int. Cl. H04L 9/32; G01P 13/00

(52) U.S. Cl. CPC H04L 9/321; G01P 13/00

(57) ABSTRACT

A tamper detection device (TDD) includes a current generation system positioned relative to a first portion and a second portion of an enclosure to generate an electric current when the first portion moves relative to the second portion, the enclosure contains a product object and the TDD powered by the product object; an electric storage device coupled to the current generation system to be charged by the electric current, the electric current is generatable when the product object is off and the TDD is unpowered; a controller that determines, within a time window since the product object is switched on and powers the TDD at a particular time, that the electric storage device is charged, generates, responsive to such determination, a tampering output indicating that a tampering event has occurred when the product object is off prior to the particular time, and transmits the tampering output to the product object.

### BACKGROUND

The present disclosure relates to tamper detection. In a more particular example, the disclosure relates to technologies for detecting a tampering event for an object contained in an enclosure.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. The sole purpose of this summary is to present some concepts in a simplified form as a prelude to the more detailed description that is presented later.

In some embodiments, a tamper detection device is provided. The tamper detection device comprises a current generation system positioned relative to a first portion of an enclosure and a second portion of the enclosure, wherein the enclosure contains a product object and the tamper detection device communicatively coupled to the product object, the tamper detection device being configured to be powered by the product object; an electric storage device coupled to the current generation system to be charged by an electric current generated by the current generation system, wherein the electric current is generated when the first portion of the enclosure moves relative to the second portion of the enclosure, and the electric current is generatable when the product object is in an off state and the tamper detection device is not powered; and a controller coupled to the electric storage device and configured to: determine, within a time window since a particular time at which the product object is switched from the off state to an on state and powers the tamper detection device, that the electric storage device is charged; generate, in response to determining that the electric storage device is charged, a tampering output indicating that a tampering event has occurred when the product object is in the off state prior to the particular time; and transmit the tampering output to the product object.

In some embodiments, a method executed by a controller of a tamper detection device is provided. The method comprises determining, within a time window since a particular time at which a product object is switched from an off state to an on state and powers the tamper detection device, that an electric storage device of the tamper detection device is charged, wherein the tamper detection device includes a current generation system positioned relative to a first portion of an enclosure and a second portion of the enclosure, the enclosure contains the product object and the tamper detection device communicatively coupled to the product object, the tamper detection device is configured to be powered by the product object, and the tamper detection device includes the electric storage device coupled to the current generation system to be charged by an electric current generated by the current generation system, the electric current is generated when the first portion of the enclosure moves relative to the second portion of the enclosure, the electric current is generatable when the product object is in the off state and the tamper detection device is not powered; generating, in response to determining that the electric storage device is charged, a tampering output indicating that a tampering event has occurred when the product object is in the off state prior to the particular time; and transmitting the tampering output to the product object.

In some embodiments, a tamper detection device is provided. The tamper detection device comprises a magnet attached to a first portion of an enclosure, wherein the enclosure contains a product object and the tamper detection device communicatively coupled to the product object, the tamper detection device is configured to be powered by the product object; a circuit board attached to a second portion of the enclosure, wherein the circuit board includes a controller, a wire coil, and a capacitor coupled to the wire coil to be charged by an induced current generated in the wire coil when a movement of the first portion of the enclosure relative to the second portion of the enclosure causes a movement of the magnet relative to the wire coil, the induced current is generatable in the wire coil when the product object is in an off state and the tamper detection device is not powered; and wherein the controller is coupled to the capacitor and configured to: determine, within a time window since a particular time at which the product object is switched from the off state to an on state and powers the tamper detection device, that the capacitor is charged; generate, in response to determining that the capacitor is charged, a tampering output indicating that a tampering event has occurred when the product object is in the off state prior to the particular time; and transmit the tampering output to the product object.

To the accomplishment of the foregoing and related ends, certain illustrative aspects are described herein in connection with the following description and the accompanying drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an example system for detecting a tampering event.

FIG. 2 illustrates an example tamper detection device.

FIGS. 3A and 3B illustrate example implementations of a current generation system.

FIG. 4 illustrates an example implementation of a tamper detection device.

FIG. 5 illustrates an example method performed by a tamper detection device.

FIG. 6 illustrates an example method performed by a product object.

### DETAILED DESCRIPTION

The present disclosure is now described with reference to the drawings. In the following description, specific details may be set forth for purposes of explanation. It should be understood that the present disclosure may be implemented without these specific details.

In this present disclosure, when elements of various embodiments are introduced, the articles “a,” “an,” “the,” and “said” are intended to mean that there are one or more of the elements. The terms “comprising,” “including,” and “having” are intended to be inclusive and are intended to mean that there may be additional elements other than the listed elements. One or more embodiments of the present disclosure will be described below. In an effort to provide a concise description of these embodiments, all features of an actual implementation may not be described in the specification. It should be understood that in the development of any such actual implementation, as in any engineering or design project, numerous implementation-specific decisions may be made to achieve specific goals, such as compliance with system-related and business-related constraints, which may vary from one implementation to another. Moreover, it should be understood that such a development effort may be complex and time consuming, but would nevertheless be a routine undertaking of design, fabrication, and manufacture for those of ordinary skill having the benefit of this present disclosure.

Various aspects or features will be presented in terms of systems that may include a number of devices, components, modules, and the like. It should be understood that various systems may include additional devices, components, modules, etc. and/or may not include all of the devices, components, modules, etc. that are discussed with reference to the figures. A combination of these approaches may also be used.

Systems and methods for tamper detection are described herein. In some systems, to protect an object, the object may be contained in a case that is closed. A tampering event may occur when the case is opened to gain physical access to the object. To detect a tampering event, a tamper-evident tape may be applied to the case. The tamper-evident tape may leave a visual indicator (e.g., a particular text) on the case when the tamper-evident tape is removed. Thus, to detect the tampering event, a user may visually inspect the case at a location where the case is placed. The user may determine that the tamper-evident tape is broken or removed, and therefore determine that the tampering event has occurred. Thus, the tamper-evident tape often requires in-person inspection and is incapable of automatically reporting to a remote user or a remote system that the tampering event has occurred. Therefore, using the tamper-evident tape for tamper detection is generally inconvenient. Alternatively, some systems may use detection devices to detect the tampering event. However, these existing detection devices often require power to operate. As a result, these existing detection devices generally cannot detect the tampering event that occurs when these detection devices are not powered.

Systems and methods described herein use a tamper detection device to detect tampering events for a product object and are capable of detecting a tampering event that occurs while the product object is in an off state and the tamper detection device is not powered. As described herein, the product object and the tamper detection device may be contained in an enclosure. The tamper detection device may be communicatively coupled to the product object and may be configured to be powered by the product object. In some embodiments, the tamper detection device may include a current generation system positioned relative to a first portion of the enclosure and a second portion of the enclosure such that an electric current may be generated by the current generation system when the first portion of the enclosure moves relative to the second portion of the enclosure. The electric current is generatable even when the product object is in the off state and the tamper detection device is not powered. The tamper detection device may also include an electric storage device coupled to the current generation system to be charged by the electric current generated by the current generation system.

In some embodiments, the tamper detection device may include a controller coupled to the electric storage device. When the product object is switched from the off state to an on state and powers the tamper detection device at a particular time, the controller may become operative. The controller may then determine, within a time window since the particular time, whether the electric storage device is charged. If the electric storage device is charged, the controller may determine that the electric storage device is charged by the electric current generated when the first portion of the enclosure is moved relative to the second portion of the enclosure to open the enclosure, and therefore determine that the tampering event has occurred when the product object is in the off state prior to the particular time. In this case, the controller may generate a tampering output indicating that the tampering event has occurred when the product object is in the off state prior to the particular time, and transmit the tampering output to the product object. On the other hand, if the electric storage device is not charged, the controller may determine that the electric current is not generated by the current generation system, and therefore determine that the tampering event in which the first portion of the enclosure is moved relative to the second portion of the enclosure to open the enclosure has not occurred when the product object is in the off state prior to the particular time. In this case, the controller may generate a non-tampering output indicating that the tampering event has not occurred when the product object is in the off state prior to the particular time, and transmit the non-tampering output to the product object.

Systems and methods described herein may be advantageous in a number of technical respects. For example, as described above, the electric current may be generated by the current generation system when the tampering event occurs in which the first portion of the enclosure is moved relative to the second portion of the enclosure to open the enclosure. The electric current is generatable even when the product object is in the off state and the tamper detection device is not powered. As described above, the electric storage device is charged by the electric current. Therefore, when the product object is switched from the off state to the on state and powers the tamper detection device, the controller may become operative and may determine that the electric storage device is charged. Because the electric storage device is charged, the controller may determine that the tampering event has occurred while the product object is in the off state. Accordingly, the tamper detection device is capable of determining that the tampering event has occurred, even if the tampering event occurs while the product object is in the off state and the tamper detection device is not powered. In addition, after the electric storage device is charged by the electric current generated by the current generation system when the tampering event occurs, the electric storage device may hold the charge for an extended period of time. Accordingly, even if the product object remains in the off state for a relatively long time (e.g., the product object may be down for a few days or even few months due to maintenance or transportation between different locations), the controller may evaluate the charge condition of the electric storage device when the product object is switched back on, and still be able to determine that the tampering event has occurred while the product object is in the off state.

In addition, as described above, when the product object is switched from the off state to the on state and powers the tamper detection device at the particular time, the controller of the tamper detection device may determine, within the time window since the particular time, whether the tampering event has occurred and transmit a tampering output or a non-tampering output to the product object. Accordingly, if the product object determines that no tampering output and no non-tampering output is received from the tamper detection device within a particular time window since the product object is switched from the off state to the on state at the particular time, the product object may determine that the tamper detection device does not communicate with the product object as expected, and therefore determine that the tamper detection device may be damaged or may be removed. In this case, the product object may transmit a tampering alert to a device management system via a secured communication channel. The tampering alert may indicate that the tampering event has occurred. Thus, the product object is capable of determining that the tampering event has occurred in case the tamper detection device is subjected to a damage attempt or removal.

Moreover, to transmit a detection output such as the tampering output or the non-tampering output to the product object, the tamper detection device may generate a cryptographic value based on the detection output. For example, the tamper detection device may generate a cryptographic value for the detection output using a private key of the tamper detection device or a secret key that is provided only to the tamper detection device and the product object. The tamper detection device may generate a notification message including the detection output and the cryptographic value, and transmit the notification message to the product object.

In some embodiments, when receiving a notification message, the product object may authenticate the notification message using a cryptographic value included in the notification message and a cryptographic key stored by the product object. For example, the product object may store a cryptographic key associated with tamper detection device such as a public key of the tamper detection device or the secret key that is provided only to the tamper detection device and the product object. If the notification message is unsuccessfully authenticated using the cryptographic key stored by the product object, the product object may determine that the notification message is transmitted by a different device that is not the tamper detection device associated with the product object or the notification message has been modified. In this case, the product object may transmit the tampering alert to the device management system via the secured communication channel. The tampering alert may indicate that the tampering event has occurred. Thus, by verifying the authenticity and the integrity of the notification message using the cryptographic key stored by the product object, the product object is capable of determining that the tampering event has occurred in case the tamper detection device is replaced with a different device or the communication of the notification message between the tamper detection device and the product object is intercepted.

On the other hand, if the notification message is successfully authenticated using the cryptographic key stored by the product object, the product object may determine whether the notification message includes the tampering output. If the notification message includes the tampering output, the product object may transmit the tampering alert to the device management system via the secured communication channel. The tampering alert may indicate that the tampering event has occurred. In some embodiments, when receiving the tampering alert from the product object, the device management system may update a tamper history of the product object and provide an alert notification to a relevant user. Thus, the tamper history of the product object may be automatically updated, and the relevant user may be informed of the tampering event that occurs to the product object and/or other objects contained in the enclosure without the need to be at the location where the enclosure is placed to perform in-person inspection.

Various illustrative embodiments will now be described in detail with reference to the figures. It should be understood that the illustrative embodiments described below are provided as examples and that other examples not explicitly described herein may also be captured by the scope of the claims set forth below. The systems and methods described herein may provide any of the benefits mentioned above, as well as various additional and/or alternative benefits that will be described and/or made apparent below.

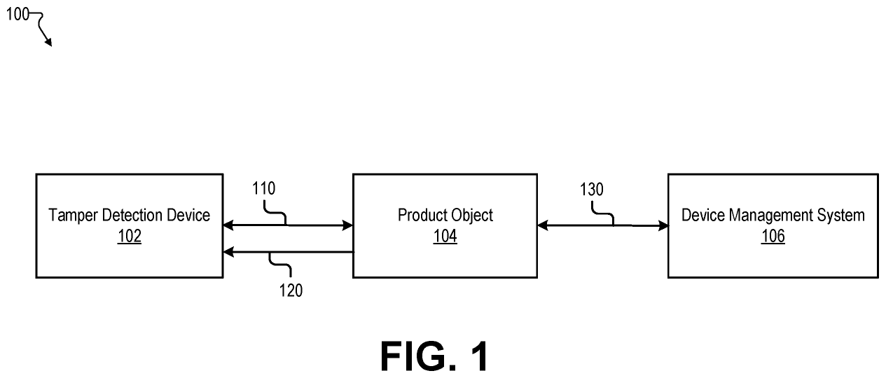

FIG. 1 illustrates an example system 100 for performing tamper detection. As depicted in FIG. 1, the system 100 may include a tamper detection device 102, a product object 104, and a device management system 106.

In some embodiments, the product object 104 may be contained in an enclosure for protection. The product object 104 may be an entire product and may be placed inside the enclosure. Alternatively, the product object 104 may be a component (e.g., a control board) of a product and may be placed inside the enclosure while other components of the product are placed outside the enclosure. In a normal condition, the enclosure may be closed.

In some embodiments, the tamper detection device 102 may be contained in the same enclosure with the product object 104. Thus, the enclosure may contain both the product object 104 and the tamper detection device 102. In some embodiments, the tamper detection device 102 may be communicatively coupled to the product object 104 via a connection 110. The connection 110 may be a wired or wireless connection through which the product object 104 and the tamper detection device 102 communicate. In some embodiments, the tamper detection device 102 may be configured to be powered by the product object 104 via a power connection 120 and may not include a separate power source such as a battery. Accordingly, when the product object 104 is in an on state, the product object 104 may supply power to the tamper detection device 102, and therefore the tamper detection device 102 is powered. When the product object 104 is in an off state, the product object 104 may not supply power to the tamper detection device 102, and therefore the tamper detection device 102 is not powered. In some embodiments, the product object 104 and the tamper detection device 102 may collaborate with one another to detect a tampering event in which a first portion of the enclosure is moved relative to a second portion of the enclosure to open the enclosure and gain physical access to the product object 104, the tamper detection device 102, and/or other objects contained in the enclosure.

In some embodiments, the device management system 106 may be a computing system that manages various devices in one or more physical environments. For example, the device management system 106 may manage various industrial assets of one or more industrial facilities. In some embodiments, the device management system 106 may be implemented on an on-premises device (e.g., a server) located in one of the physical environments. Additionally or alternatively, the device management system 106 may be implemented on a cloud platform. In some embodiments, the device management system 106 may be communicatively coupled to the product object 104 via a connection 130. The connection 130 may be a wired or wireless connection through which the device management system 106 and the product object 104 communicate. In some embodiments, the connection 130 may be a secured connection (e.g., a Virtual Private Network (VPN) connection, a network connection within a plant network behind a firewall, etc.) and therefore the communication between the device management system 106 and the product object 104 is protected.

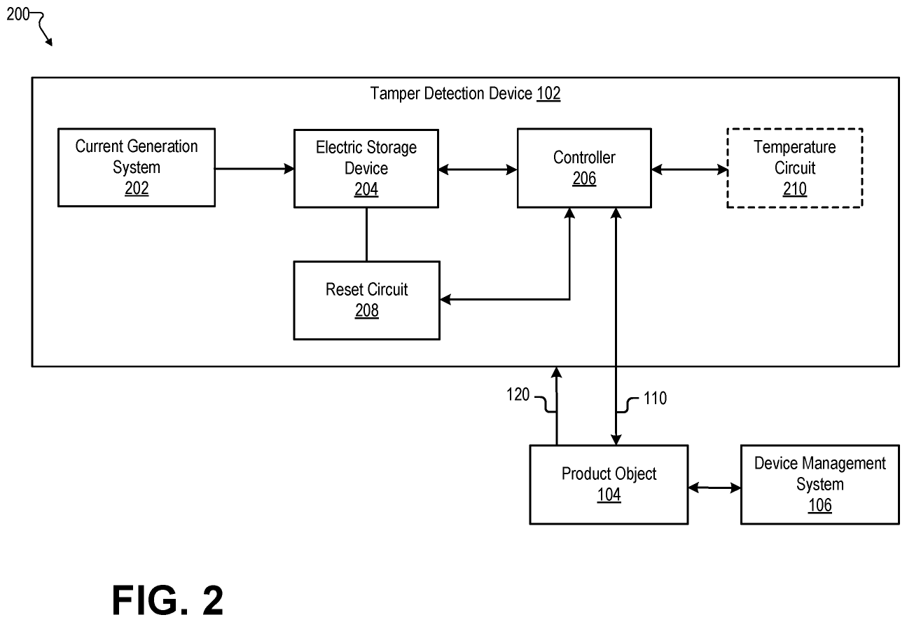

FIG. 2 shows a diagram 200 illustrating an example of the tamper detection device 102. As depicted in FIG. 2, the tamper detection device 102 may include a current generation system 202, an electric storage device 204, a controller 206, and a reset circuit 208. The tamper detection device 102 may optionally include a temperature circuit 210 as depicted in FIG. 2.

In some embodiments, the current generation system 202 may be configured to generate an electric current based on a state of the enclosure in which the tamper detection device 102 and the product object 104 are contained. In some embodiments, the enclosure may include a first portion of the enclosure and a second portion of the enclosure. For example, the first portion of the enclosure may be a lid of the enclosure, and the second portion of the enclosure may be a remaining portion of the enclosure in which the product object 104 and one or more components of the tamper detection device 102 are placed. In some embodiments, when the enclosure is closed, the first portion of the enclosure may be in a close position. When the enclosure is opened, the first portion of the enclosure may be moved relative to the second portion of the enclosure and may no longer be in the close position. In some embodiments, the current generation system 202 may be positioned relative to the first portion of the enclosure and the second portion of the enclosure. For example, the current generation system 202 may include one or more components (e.g., a magnet, a wire coil, a piezoelectric sensor, etc.) and these components may be positioned relative to the first portion of the enclosure and the second portion of the enclosure to generate an electric current when the first portion of the enclosure moves relative to the second portion of the enclosure. Accordingly, the electric current may be generated when the enclosure is opened in which the first portion of the enclosure moves relative to the second portion of the enclosure. In some embodiments, the current generation system 202 may be capable of generating the electric current when the enclosure is opened and the first portion of the enclosure moves relative to the second portion of the enclosure even if the product object 104 is in the off state and therefore the tamper detection device 102 is not powered at that time.

In some embodiments, the electric storage device 204 may be coupled to the current generation system 202 to be charged by the electric current generated by the current generation system 202. In some embodiments, an electrical element such as a diode may be positioned between the current generation system 202 and the electric storage device 204 to direct the electric current generated by the current generation system 202 to the electric storage device 204. The diode may also prevent a leakage current that flows from the electric storage device 204 to the current generation system 202 in the opposite direction. In some embodiments, another electrical element such as a transient voltage suppression (TVS) diode may also be positioned between the current generation system 202 and other components of the tamper detection device 102 to protect other components of the tamper detection device 102 from being damaged in case the electric current generated by the current generation system 202 causes an overvoltage condition.

In some embodiments, the electric storage device 204 may be implemented using a capacitor. In this case, the capacitor may be coupled to the current generation system 202 to be charged by the electric current generated by the current generation system 202. In some embodiments, one or more electrical elements (e.g., a diode, a resistor, a field-effect transistor (FET), an analog-to-digital converter (ADC), etc.) that are directly connected to the capacitor may be low-leakage electrical elements. For example, these electrical elements may have high resistance and/or high impedance to minimize the leakage current from the capacitor through these electrical elements over time. As a result, once the capacitor is charged by the electric current generated by the current generation system 202, the capacitor may hold a majority of the charge for an extended period of time (e.g., 5 hours, 2.5 days, 4 weeks, 3 months, etc.) and the charge condition of the capacitor may be used to determine whether a tampering event has occurred.

In some embodiments, the electric storage device 204 may be implemented using a non-volatile memory such as Electrically Erasable Programmable Read-Only Memory (EEPROM), Ferroelectric Random Access Memory (FRAM), Magnetoresistive Random Access Memory (MRAM), Phase-change Random Access Memory (PRAM), etc. In this case, the non-volatile memory may be coupled to the current generation system 202. The electric current generated by the current generation system 202 may be directed to the non-volatile memory and may charge an internal capacitor or other types of electric storage element in the non-volatile memory to set a value (e.g., bit 1) in the non-volatile memory. Once the value is written to the non-volatile memory, the value may be stored in the non-volatile memory for an extended period of time (e.g., 6 months, 5 years, etc.) and the value may be used to determine whether a tampering event has occurred. Other implementations of the electric storage device 204 are also possible and contemplated.

In some embodiments, the controller 206 may be configured to control various operations of the tamper detection device 102. For example, the controller 206 may receive input signals from and transmit control signals to various components of the tamper detection device 102. The controller 206 may execute a control program to process the input signals and provide the control signals and/or other outputs to perform various functions of the tamper detection device 102. For example, the controller 206 may execute the control program to generate a detection output (e.g., a tampering output or a non-tampering output) and transmit the detection output to the product object 104 via the connection 110 as depicted in FIG. 2. In some embodiments, the control program may include any type of code such as ladder logic, sequential function charts, function block diagrams, structured text, and/or other programming structures.

In some embodiments, the controller 206 may operate only when the tamper detection device 102 is powered. As described herein, the tamper detection device 102 may be powered only by the product object 104 via the power connection 120 and may not include a separate power source that supplies power to the controller 206 such as a battery. Accordingly, when the product object 104 is in the on state, the product object 104 may supply power to the tamper detection device 102. As a result, the tamper detection device 102 may be powered and the controller 206 may be operative. On the other hand, when the product object 104 is in the off state, the product object 104 may not supply power to the tamper detection device 102. As a result, the tamper detection device 102 may not be powered and the controller 206 may be inoperative. Thus, the controller 206 may operate only when the product object 104 is in the on state and supplies power to the tamper detection device 102 and the controller 206 included in the tamper detection device 102.

As depicted in FIG. 2, the controller 206 may be coupled to the electric storage device 204, the reset circuit 208, and the temperature circuit 210. To enable the operations of the controller 206 and these components, one or more electrical elements (e.g., a resistor, a comparator, an ADC, etc.) may be included in the tamper detection device 102 as necessary. In some embodiments, the controller 206 may obtain one or more values from these components and generate an output (e.g., a tampering output or a non-tampering output) based on these values. The controller 206 may also provide control signals to these components to control the operations of these components when performing the functions of the tamper detection device 102.

As an example, the electric storage device 204 may be implemented in the form of a capacitor as described above. In this case, the controller 206 may determine whether a voltage of the capacitor satisfies a voltage threshold. For example, based on an input from an ADC or a comparator coupled to the capacitor, the controller 206 may determine that voltage of the capacitor is higher than the voltage threshold, and therefore determine that the capacitor is charged. Because the capacitor is charged, the controller 206 may determine that the current generation system 202 generates the electric current that charges the capacitor when the first portion of the enclosure moves relative to the second portion of the enclosure. Accordingly, the controller 206 may determine that the tampering event has occurred in which the first portion of the enclosure is moved relative to the second portion of the enclosure to open the enclosure. In response to such determination, the controller 206 may generate a tampering output indicating that the tampering event has occurred, and transmit the tampering output to the product object 104. The controller 206 may also discharge the capacitor to reset the capacitor using the reset circuit 208.

As another example, the electric storage device 204 may be implemented in the form of a non-volatile memory (e.g., an EEPROM) as described above. In this case, the controller 206 may read the value stored in the non-volatile memory, and determine whether the value stored in the non-volatile memory matches a predefined value (e.g., bit 1). If the value stored in the non-volatile memory matches the predefined value, the controller 206 may determine that the non-volatile memory receives the electric current that charges the electric storage element (e.g., the internal capacitor) in the non-volatile memory and sets the value (e.g., bit 1) in the non-volatile memory. Because the non-volatile memory receives the electric current, the controller 206 may determine that the current generation system 202 generates the electric current provided to the non-volatile memory when the first portion of the enclosure moves relative to the second portion of the enclosure. Accordingly, the controller 206 may determine that the tampering event has occurred in which the first portion of the enclosure is moved relative to the second portion of the enclosure to open the enclosure. In response to such determination, the controller 206 may generate a tampering output indicating that the tampering event has occurred, and transmit the tampering output to the product object 104. The controller 206 may also overwrite the value stored in the non-volatile memory with a default value (e.g., bit 0) to reset the non-volatile memory. Other operations performed by the controller 206 are also possible and contemplated.

In some embodiments, the reset circuit 208 may be coupled to the electric storage device 204 and may be used by the controller 206 to reset the electric storage device 204. For example, the reset circuit 208 may include a switch element such as an electronic switch (e.g., a Junction Field Effect Transistor (JFET), etc.) or a mechanical switch (e.g., a relay, etc.). To reset the electric storage device 204 such as a capacitor, the controller 206 may provide a control signal to close the switch element. When the switch element is closed, the capacitor may be connected to the ground and thus the charge on the capacitor is drained. As a result, the capacitor may be discharged and reset for another tamper detection. Other implementations of the reset circuit 208 are also possible and contemplated.

In some embodiments, the temperature circuit 210 may be coupled to the controller 206 and may be used by the controller 206 to determine whether a temperature of a surrounding environment in which the tamper detection device 102 operates satisfies a temperature threshold. In some embodiments, when the temperature increases, the leakage rates of the electrical elements (e.g., the diode, etc.) that are directly connected to the electric storage device 204 such as the capacitor may increase. In this case, the leakage current from the capacitor through these electrical elements may increase and may result in a significant loss of charge on the capacitor. In some embodiments, the significant loss of charge on the capacitor may cause the controller 206 to determine that the capacitor is not charged, and therefore determine that the electric current is not generated by the current generation system 202. In this case, the controller 206 may determine that the tampering event in which the first portion of the enclosure is moved relative to the second portion of the enclosure to open the enclosure has not occurred. However, this detection result is a false negative.

In some embodiments, to detect the high temperature in the surrounding environment, the temperature circuit 210 may include a thermal fuse. When the temperature exceeds a temperature threshold, the thermal fuse may melt and result in the temperature circuit 210 being an open circuit. In some embodiments, based on a current value or a voltage value associated with the temperature circuit 210, the controller 206 may determine that the temperature circuit 210 is open and the thermal fuse is melted. In this case, the controller 206 may determine that the temperature of the surrounding environment in which the tamper detection device 102 operates exceeds the temperature threshold, and transmit a temperature warning message to the product object 104. In some embodiments, when receiving the temperature warning message, the product object 104 may determine that the non-tampering outputs provided by the tamper detection device 102 may be false negative due to the high temperature. Additionally or alternatively, the product object 104 may determine that the tamper detection device 102 may be heated in an attempt to change its detection result, and therefore determine that the tampering event has occurred. Other implementations of the temperature circuit 210 are also possible and contemplated.

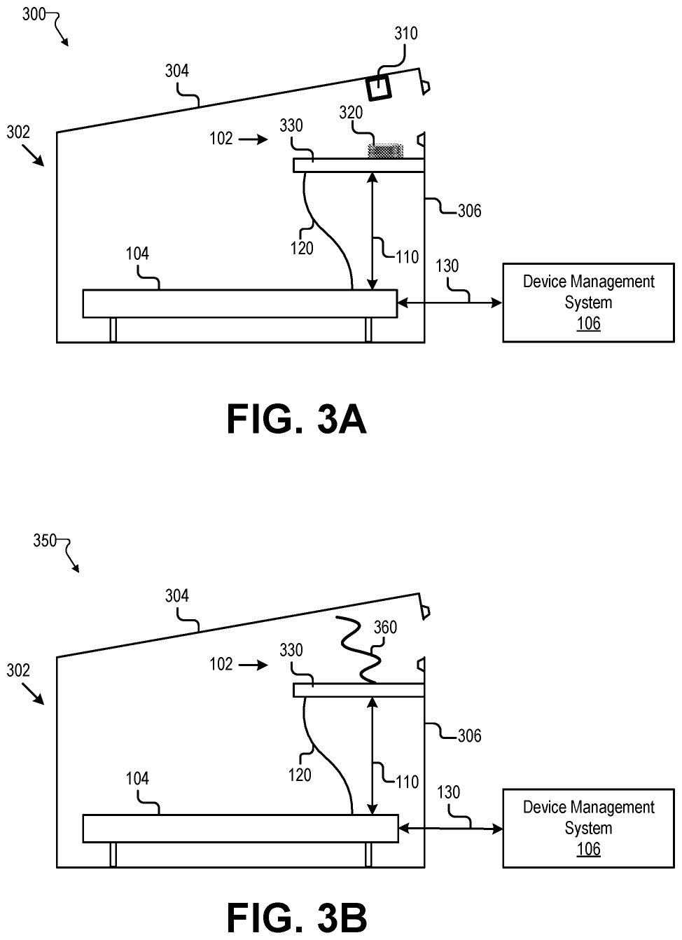

FIG. 3A shows a diagram 300 illustrating an example implementation of the current generation system 202 in the tamper detection device 102. As depicted in FIG. 3A, the product object 104 and the tamper detection device 102 may be contained in an enclosure 302. The enclosure 302 may include a first portion 304 of the enclosure 302 and a second portion 306 of the enclosure 302. The first portion 304 may be a lid of the enclosure 302 and the second portion 306 may be a remaining portion of the enclosure 302 in which the product object 104 and one or more components of the tamper detection device 102 are placed as depicted in FIG. 3A. In a normal condition, the enclosure 302 may be closed and the first portion 304 of the enclosure 302 may be in the close position. When the enclosure 302 is closed, the first portion 304 of the enclosure 302 and the second portion 306 of the enclosure 302 may form a closed space in which the product object 104 and the tamper detection device 102 are contained, and therefore physical access to the product object 104 and the tamper detection device 102 may be prevented. When a tampering event occurs, the tampering event may include the first portion 304 of the enclosure 302 being moved relative to the second portion 306 of the enclosure 302 to open the enclosure 302, which creates an opening between the first portion 304 of the enclosure 302 and the second portion 306 of the enclosure 302 through which the product object 104 and the tamper detection device 102 can be physically accessed. The first portion 304 of the enclosure 302 may be referred to herein as the first portion of the enclosure 302, and the second portion 306 of the enclosure 302 may be referred to herein as the second portion of the enclosure 302.

As depicted in FIG. 3A, the current generation system 202 of the tamper detection device 102 may include a magnet 310 attached to the first portion of the enclosure 302 and a wire coil 320 being placed at a fixed position relative to the second portion of the enclosure 302. For example, the wire coil 320 may be attached to the second portion of the enclosure 302. Alternatively, the tamper detection device 102 may include a circuit board 330 attached to the second portion of the enclosure 302 and the wire coil 320 may be positioned on the circuit board 330 as depicted in FIG. 3A. In some embodiments, the circuit board 330 may include the wire coil 320, the electric storage device 204 (e.g., a capacitor, a non-volatile memory, etc.) coupled to the wire coil 320, the controller 206, the reset circuit 208, the temperature circuit 210, and/or other elements of the tamper detection device 102.

In some embodiments, the components of the tamper detection device 102 may be incorporated into an integrated circuit chip. For example, the integrated circuit chip may include the electric storage device 204, the controller 206, and/or one or more additional elements of the tamper detection device 102. In some embodiments, while other components of the tamper detection device 102 may be included in the integrated circuit chip, the magnet 310 may not be included in the integrated circuit chip due to its position, and the wire coil 320 may or may not be included in the integrated circuit chip. Incorporating the components of the tamper detection device 102 into the integrated circuit chip is advantageous, because this implementation requires significant effort to alter the tamper detection device 102 and its operations due to a small size and a compact design of the integrated circuit chip.

Additionally or alternatively, the components of the tamper detection device 102 may be incorporated into the product object 104. For example, the product object 104 may be a control board of a product and the electric storage device 204, the controller 206, and/or one or more additional elements of the tamper detection device 102 may be integrated as part of the product object 104. In some embodiments, while other components of the tamper detection device 102 may be included in the product object 104, the magnet 310 may not be included in the product object 104 due to its position, and the wire coil 320 may or may not be included in the product object 104. Integrating the components of the tamper detection device 102 as part of the product object 104 is advantageous, because this implementation simplifies the communication between the tamper detection device 102 and the product object 104 and such communication is also less prone to interception.

As described above, the current generation system 202 may include the magnet 310 attached to the first portion of the enclosure 302 and the wire coil 320 being placed at the fixed position relative to the second portion of the enclosure 302. In some embodiments, the magnet 310 may be positioned relative to the wire coil 320 such that at least a portion of the magnet 310 is located within the wire coil 320 when the enclosure 302 is closed and the first portion of the enclosure 302 is in the close position. In some embodiments, when the tampering event occurs and the enclosure 302 is opened, a movement of the first portion of the enclosure 302 relative to the second portion of the enclosure 302 to open the enclosure 302 may cause a movement of the magnet 310 relative to the wire coil 320. For example, the movement of the first portion of the enclosure 302 relative to the second portion of the enclosure 302 when the enclosure 302 is opened may cause the magnet 310 to move away from the wire coil 320. Such movement of the magnet 310 may cause a change of magnetic flux through the wire coil 320, which results in an induced current generated in the wire coil 320. Thus, the induced current may be generated in the wire coil 320 when the enclosure 302 is opened and the first portion of the enclosure 302 moves relative to the second portion of the enclosure 302. Accordingly, the induced current may be generated in the wire coil 320 when the tampering event occurs and the enclosure 302 is opened. As the induced current is generated based on the physical movement of the first portion of the enclosure 302 relative to the second portion of the enclosure 302, the induced current may be generatable even when the product object 104 is in the off state and therefore the tamper detection device 102 is not powered and the controller 206 of the tamper detection device 102 is inoperative at that time.

In some embodiments, the first portion of the enclosure 302 and the second portion of the enclosure 302 may be coupled to one another in a specific manner such that the movement of the first portion of the enclosure 302 relative to the second portion of the enclosure 302 when the enclosure 302 is opened may occur within a time duration that satisfies a time duration threshold (e.g., less than 120 ms). For example, the first portion of the enclosure 302 may be coupled to the second portion of the enclosure 302 using specific latches so that when the enclosure 302 is opened, the first portion of the enclosure 302 may pop open quickly and cause a rapid movement of the magnet 310 relative to the wire coil 320. The rapid movement of the magnet 310 relative to the wire coil 320 may cause a significant change of magnetic flux through the wire coil 320, and therefore the induced current generated in the wire coil 320 may have a substantial voltage (e.g., 0.5V).

In some embodiments, the wire coil 320 may be coupled to the electric storage device 204 and the electric storage device 204 may be charged by the induced current generated in the wire coil 320. As described above, the induced current may be generated in the wire coil 320 when the enclosure 302 is opened and the first portion of the enclosure 302 moves relative to the second portion of the enclosure 302. Thus, the electric storage device 204 may be charged when the tampering event occurs in which the first portion of the enclosure 302 is moved relative to the second portion of the enclosure 302 to open the enclosure 302.

In some embodiments, the magnet 310, the wire coil 320, and/or other components of the tamper detection device 102 may be protected by a magnetic shield. The magnetic shield may be made of material that has high magnetic permeability such as mu-metal. In some embodiments, the magnetic shield may protect the magnet 310 and the wire coil 320 from impact of an external magnetic field generated by a nearby device. Additionally or alternatively, the magnetic shield may protect the magnet 310 and the wire coil 320 in case a different magnetic field associated with a different magnetic object is used to reduce the strength or the intensity of the magnetic field associated with the magnet 310 in an attempt to change the operations of the tamper detection device 102 and bypass the tamper detection device 102.

Another example implementation of the current generation system 202 is depicted in a diagram 350 of FIG. 3B. As depicted in FIG. 3B, the current generation system 202 may include a piezoelectric sensor 360 instead of the magnet 310 and the wire coil 320. In some embodiments, the piezoelectric sensor 360 may be positioned relative to the first portion of the enclosure 302 and the second portion of the enclosure 302 such that the piezoelectric sensor 360 is in physical contact with the first portion of the enclosure 302 when the enclosure 302 is closed. For example, when the enclosure 302 is closed and the first portion of the enclosure 302 is in the close position, the piezoelectric sensor 360 may rest against the first portion of the enclosure 302 and the first portion of the enclosure 302 may keep the piezoelectric sensor 360 in a folded state or a compressed state. When the tampering event occurs and the enclosure 302 is opened, the first portion of the enclosure 302 may move relative to the second portion of the enclosure 302 and the first portion of the enclosure 302 may no longer be in the close position to keep the piezoelectric sensor 360 in the folded state or the compressed state. Thus, the movement of the first portion of the enclosure 302 relative to the second portion of the enclosure 302 when the enclosure 302 is opened may cause a deformation of the piezoelectric sensor 360, which results in an electric current generated in the piezoelectric sensor 360 due to the piezoelectric effect of the piezoelectric material that the piezoelectric sensor 360 is made of. Thus, the electric current may be generated in the piezoelectric sensor 360 when the enclosure 302 is opened and the first portion of the enclosure 302 moves relative to the second portion of the enclosure 302. Accordingly, the electric current may be generated in the piezoelectric sensor 360 when the tampering event occurs and the enclosure 302 is opened. As the electric current is generated based on the physical movement of the first portion of the enclosure 302 relative to the second portion of the enclosure 302, the electric current may be generatable even when the product object 104 is in the off state and therefore the tamper detection device 102 is not powered and the controller 206 of the tamper detection device 102 is inoperative at that time.

In some embodiments, the piezoelectric sensor 360 may be coupled to the electric storage device 204 and the electric storage device 204 may be charged by the electric current generated in the piezoelectric sensor 360. As described above, the electric current may be generated in the piezoelectric sensor 360 when the enclosure 302 is opened and the first portion of the enclosure 302 moves relative to the second portion of the enclosure 302. Thus, the electric storage device 204 may be charged when the tampering event occurs in which the first portion of the enclosure 302 is moved relative to the second portion of the enclosure 302 to open the enclosure 302. As described herein, the components of the tamper detection device 102 may be implemented on the circuit board 330, incorporated into an integrated circuit chip, and/or integrated into the product object 104 as part of the product object 104. In these cases, the piezoelectric sensor 360 may be connected to the electric storage device 204 that is implemented on the circuit board 330, included in the integrated circuit chip, and/or integrated into the product object 104.

It should be understood that the implementations of the current generation system 202 described above with reference to FIGS. 3A and 3B are merely examples. Other implementations of the current generation system 202 that is capable of generating the electric current when the first portion of the enclosure 302 is moved relative to the second portion of the enclosure 302 to open the enclosure 302 are also possible and contemplated.

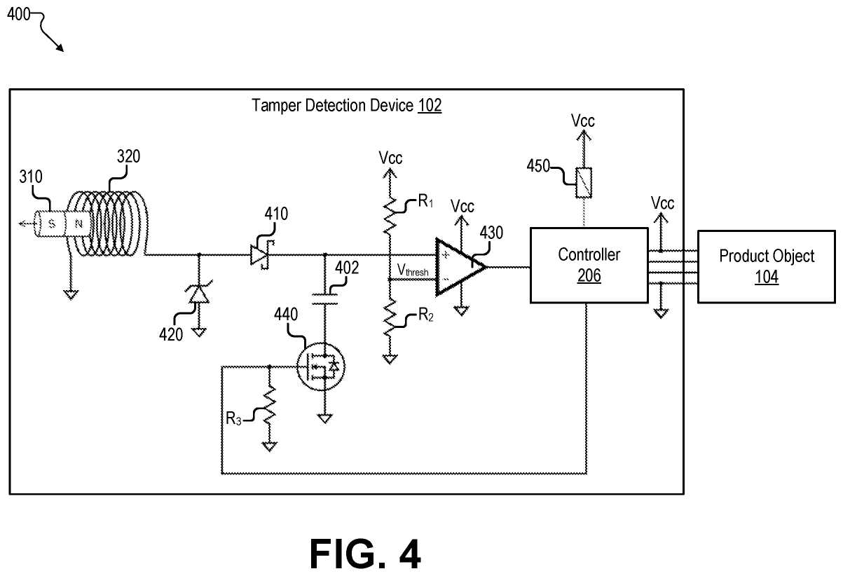

FIG. 4 shows a diagram 400 illustrating an example implementation of the tamper detection device 102. As depicted in FIG. 4, the tamper detection device 102 may include the magnet 310, the wire coil 320, a capacitor 402, a diode 410, a TVS diode 420, a comparator 430, a FET 440, a thermal fuse 450, and the controller 206. To enable the operations of these components, the tamper detection device 102 may also include other electrical elements (e.g., resistors R1, R2, R3, etc.) as necessary. In some embodiments, the tamper detection device 102 depicted in FIG. 4 may be implemented on the circuit board 330 with the magnet 310 being attached to the first portion of the enclosure 302 and therefore being external to the circuit board 330. Additionally or alternatively, the components of the tamper detection device 102 except for the magnet 310 may be included in an integrated circuit chip and/or integrated into the product object 104 as described herein.

As depicted in FIG. 4, the tamper detection device 102 may include the magnet 310 and the wire coil 320 that perform the functionality of the current generation system 202. Due to the movement of the magnet 310 relative to the wire coil 320 when the first portion of the enclosure 302 moves relative to the second portion of the enclosure 302, an electric current (e.g., an induced current) may be generated in the wire coil 320 when the first portion of the enclosure 302 is moved relative to the second portion of the enclosure 302 to open the enclosure 302 as described above.

As depicted in FIG. 4, the tamper detection device 102 may include the capacitor 402 and the diode 410 positioned between the wire coil 320 and the capacitor 402. In some embodiments, the capacitor 402 may operate as the electric storage device 204. For example, when the electric current is generated in the wire coil 320, the diode 410 may direct the electric current to the capacitor 402 and the capacitor 402 may be charged by the electric current. In some embodiments, the diode 410 may allow the electric current to flow from the wire coil 320 to the capacitor 402 but prevent the leakage current from flowing from the capacitor 402 to the wire coil 320 in the opposite direction. In addition, the electrical elements that are directly connected to the capacitor 402 (e.g., the diode 410, the comparator 430, the FET 440, etc.) may be low-leakage electrical elements. For example, these electrical elements may have high resistance and/or high impedance to minimize the leaking of charge from the capacitor 402 through these electrical elements over time. As a result, once the capacitor 402 is charged by the electric current generated in the wire coil 320, the capacitor 402 may hold a majority of the charge for an extended period of time (e.g., 6 hours, 3 days, 4 weeks, etc.).

In some embodiments, the leakage rates of the electrical elements that are directly connected to the capacitor 402 may depend on the temperature of the surrounding environment in which the tamper detection device 102 operates. For example, when the temperature increases, the leakage current (e.g., the reverse current) of the diode 410 may increase and may result in a significant loss of charge on the capacitor 402 through the diode 410. The significant loss of charge on the capacitor 402 may cause the controller 206 to determine that the capacitor is not charged, and therefore determine that the electric current is not generated in the wire coil 320. In this case, the controller 206 may determine that the tampering event in which the first portion of the enclosure 302 is moved relative to the second portion of the enclosure 302 to open the enclosure 302 has not occurred. However, this detection result is a false negative.

In some embodiments, to detect the high temperature in the surrounding environment of the tamper detection device 102, the tamper detection device 102 may include the thermal fuse 450 as depicted in FIG. 4. The thermal fuse 450 may be connected to a supply voltage V_{cc} that has a supply voltage value (e.g., 5V) provided by the product object 104 to the tamper detection device 102 when the product object 104 is in the on state and powers the tamper detection device 102. The thermal fuse 450 may also be connected to an input pin of the controller 206, and thus the thermal fuse 450 may be positioned between the controller 206 and the supply voltage V_{cc} as depicted in FIG. 4. The thermal fuse 450 being positioned between the supply voltage V_{cc} and the controller 206 as depicted in FIG. 4 is an example implementation of the temperature circuit 210. Other implementations of the temperature circuit 210 are also possible and contemplated.

In some embodiments, to detect the high temperature in the surrounding environment of the tamper detection device 102, the controller 206 may monitor a voltage value on the input pin connected to the thermal fuse 450. For example, the controller 206 may determine that voltage value on the input pin is equal to the supply voltage value (e.g., 5V), and therefore determine that the input pin is connected to the supply voltage V_{cc} through the thermal fuse 450. Accordingly, the controller 206 may determine that the thermal fuse 450 is not melted, and therefore determine that the temperature does not exceed the temperature threshold. Alternatively, the controller 206 may determine that voltage value on the input pin is equal to 0V, and therefore determine that the input pin is no longer connected to the supply voltage V_{cc}. In this case, the controller 206 may determine that the thermal fuse 450 is melted due to the high temperature and causes an open circuit. Accordingly, the controller 206 may determine that the temperature exceeds the temperature threshold.

As described herein, in response to determining that the temperature exceeds the temperature threshold, the controller 206 may transmit the temperature warning message to the product object 104. When receiving the temperature warning message, the product object 104 may determine that the non-tampering outputs provided by the tamper detection device 102 may be false negative due to the high temperature. Additionally or alternatively, the product object 104 may determine that the tamper detection device 102 may be heated in an attempt to change its detection result, and therefore determine that the tampering event has occurred.

In some embodiments, to protect the components of the tamper detection device 102, the tamper detection device 102 may also include the TVS diode 420 positioned between the wire coil 320 and the diode 410 as depicted in FIG. 4. The TVS diode 420 may perform a voltage clamping operation when the electric current generated in the wire coil 320 causes an overvoltage condition, thereby protecting the components of the tamper detection device 102 that are positioned opposite to the wire coil 320 with reference to the TVS diode 420.

Thus, as described above, the electric current (e.g., the induced current) may be generated in the wire coil 320 when the first portion of the enclosure 302 is moved relative to the second portion of the enclosure 302 to open the enclosure 302. Because the electric current is generated based on the physical movement of the first portion of the enclosure 302 relative to the second portion of the enclosure 302, the electric current may be generated even when the product object 104 is in the off state and therefore the tamper detection device 102 is not powered and the controller 206 of the tamper detection device 102 is inoperative at that time. As described above, when the electric current is generated in the wire coil 320, the diode 410 may direct the electric current to the capacitor 402 and the capacitor 402 may be charged by the electric current. Accordingly, based on the charge condition of the capacitor 402, the controller 206 may determine whether the electric current is generated, and therefore determine whether the tampering event has occurred in which the first portion of the enclosure 302 is moved relative to the second portion of the enclosure 302 to open the enclosure 302. In some embodiments, the controller 206 may evaluate the charge condition of the capacitor 402 and determine whether the tampering event has occurred based on the charge condition of the capacitor 402 only when the controller 206 is operative. Thus, the controller 206 may determine whether the tampering event has occurred based on the charge condition of the capacitor 402 only when the product object 104 is in the on state and supplies power to the tamper detection device 102 and the controller 206 included in the tamper detection device 102.

In some embodiments, the product object 104 may be switched from the off state to the on state and powers the tamper detection device 102 at a particular time. When the product object 104 powers the tamper detection device 102 at the particular time, the controller 206 may become operative. In some embodiments, within a predefined time window (e.g., 2 minutes) since the particular time at which the product object 104 is switched from the off state to the on state and the controller 206 becomes operative, the controller 206 may evaluate the charge condition of the capacitor 402 to determine whether the tampering event has occurred when the product object 104 is in the off state prior to the particular time. For example, as depicted in FIG. 4, the controller 206 may receive an input from the comparator 430 which compares the voltage of the capacitor 402 to a voltage threshold (e.g., 10 mV). Based on the input received from the comparator 430, the controller 206 may determine that the voltage of the capacitor 402 satisfies the voltage threshold (e.g., higher than 10 mV) and therefore determine that the capacitor 402 is charged. Because the capacitor 402 is charged, the controller 206 may determine that an electric current is generated in the wire coil 320 and charges the capacitor 402 when the first portion of the enclosure 302 is moved relative to the second portion of the enclosure 302. Accordingly, the controller 206 may determine that the tampering event has occurred in which the first portion of the enclosure 302 is moved relative to the second portion of the enclosure 302 to open the enclosure 302 while the product object 104 is in the off state prior to the particular time. In this case, the controller 206 may generate a tampering output indicating that the tampering event has occurred when the product object 104 is in the off state prior to the particular time, and transmit the tampering output to the product object 104.

In some embodiments, subsequent to determining that the capacitor 402 is charged, the controller 206 may discharge the capacitor 402 to reset the capacitor 402. For example, the controller 206 may discharge the capacitor 402 using the FET 440. The FET 440 may perform the functionality of the reset circuit 208 and may operate as an electronic switch that connects to the capacitor 402 as depicted in FIG. 4. In some embodiments, to discharge the capacitor 402, the controller 206 may apply a control voltage to the FET 440 to put the FET 440 in a low impedance state. When the FET 440 is in the low impedance state, the FET 440 may be considered a closed switch and may connect the capacitor 402 to the ground. When the capacitor 402 is connected to the ground, the charge on the capacitor 402 may be drained, and thus the capacitor 402 is discharged and reset to be used in a subsequent tamper detection.

It should be understood that the implementation of the tamper detection device 102 depicted in FIG. 4 is merely an example. The tamper detection device 102 may be implemented with different components being used to perform the functionalities of the current generation system 202, the electric storage device 204, the reset circuit 208, and/or other components of the tamper detection device 102. As an example, the tamper detection device 102 may include a piezoelectric sensor being used to implement the current generation system 202 instead of the magnet 310 and the wire coil 320 as depicted in FIG. 4. Additionally or alternatively, the tamper detection device 102 may include a non-volatile memory being used to implement the electric storage device 204 instead of the capacitor 402 as depicted in FIG. 4. Additionally or alternatively, the tamper detection device 102 may include a mechanical relay being used to implement the reset circuit 208 instead of the FET 440 as depicted in FIG. 4. In these implementations, the tamper detection device 102 may operate in a similar manner as described above with reference to FIGS. 2-4. Other implementations of the tamper detection device 102 and its components are also possible and contemplated.

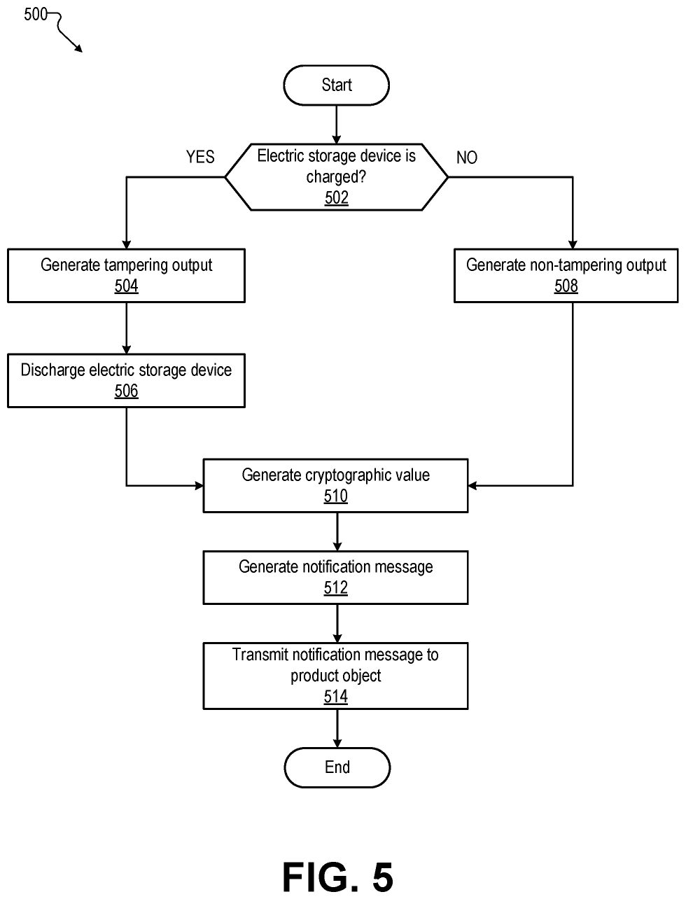

FIG. 5 illustrates an example method 500 for performing tamper detection. While FIG. 5 shows illustrative operations according to one embodiment, other embodiments may omit, add to, reorder, and/or modify any of the operations shown in FIG. 5. In some examples, multiple operations shown in FIG. 5 or described in relation to FIG. 5 may be performed concurrently (e.g., in parallel) with one another, rather than being performed sequentially as illustrated and/or described. One or more of the operations shown in FIG. 5 may be performed by the tamper detection device 102 and/or any implementation thereof. For example, the operations in FIG. 5 may be performed by the controller 206 of the tamper detection device 102 when the controller 206 is operative.

In some embodiments, the controller 206 may perform the method 500 within a predefined time window (e.g., 2 minutes) since a particular time at which the product object 104 is switched from the off state to the on state and therefore the tamper detection device 102 is powered and the controller 206 becomes operative. In this case, the controller 206 may perform the method 500 to determine whether the tampering event has occurred while the product object 104 is in the off state and the tamper detection device 102 is not powered prior to the particular time. The method 500 is described below in this context as an example. However, it should be understood that the controller 206 may perform the method 500 at any point in time while the tamper detection device 102 is powered and the controller 206 is operative.

At operation 502, the controller 206 may determine whether the electric storage device 204 is charged. As described herein, an electric current may be generated by the current generation system 202 when the first portion of the enclosure 302 moves relative to the second portion of the enclosure 302. Accordingly, the electric current may be generated when the tampering event occurs in which the first portion of the enclosure 302 is moved relative to the second portion of the enclosure 302 to open the enclosure 302 and the electric storage device 204 may be charged by the electric current. As described herein, because the electric current is generated based on the physical movement of the first portion of the enclosure 302 relative to the second portion of the enclosure 302, the electric current may be generated and the electric storage device 204 may be charged by the electric current even when the product object 104 is in the off state and therefore the tamper detection device 102 is not powered and the controller 206 of the tamper detection device 102 is inoperative at that time.

In some embodiments, when the product object 104 is switched from the off state to the on state and powers the tamper detection device 102 at the particular time, the controller 206 may become operative and may determine whether the electric storage device 204 is charged. As described above, the determination of whether the electric storage device 204 is charged may be performed by the controller 206 within the time window (e.g., 2 minutes) since the particular time at which the product object 104 is switched from the off state to the on state and powers the tamper detection device 102. By determining the charge condition of the electric storage device 204 within a relatively short time window since the particular time at which the product object 104 is switched from the off state to the on state and powers the tamper detection device 102, the controller 206 may determine whether the tampering event has occurred while the product object 104 is in the off state prior to the particular time based on the charge condition of the electric storage device 204.

In some embodiments, the controller 206 may determine the charge condition of the electric storage device 204 based on the voltage of the electric storage device 204 or the value stored in the electric storage device 204. As an example, the electric storage device 204 may be implemented using a capacitor such as the capacitor 402. In this case, based on an input from a comparator (e.g., the comparator 430) and/or an ADC coupled to the capacitor, the controller 206 may determine that the voltage of the capacitor satisfies a voltage threshold (e.g., higher than 10 mV), and therefore determine that the capacitor is charged. Thus, in this case, the controller 206 may determine that the voltage of the electric storage device 204 satisfies the voltage threshold, and therefore determine that the electric storage device 204 is charged.

As another example, the electric storage device 204 may be implemented using a non-volatile memory (e.g., an EEPROM). In this case, the controller 206 may read the value stored in the non-volatile memory, and determine whether the value stored in the non-volatile memory matches a predefined value (e.g., bit 1). If the value stored in the non-volatile memory matches the predefined value, the controller 206 may determine that the electric storage element (e.g., the internal capacitor) in the non-volatile memory is charged by an electric current and therefore the value (e.g., bit 1) is written to the non-volatile memory. Accordingly, the controller 206 may determine that the non-volatile memory receives the electric current and the electric storage element of the non-volatile memory is charged by the electric current. Thus, in this case, the controller 206 may determine that the electric storage device 204 stores the value that matches the predefined value, and therefore determine that the electric storage device 204 is charged.

In some embodiments, if at operation 502, the controller 206 determines that the electric storage device 204 is charged, the method 500 may proceed to operation 504. At operation 504, the controller 206 may generate a tampering output indicating that a tampering event has occurred. In this case, because the electric storage device 204 is charged, the controller 206 may determine that the current generation system 202 generates the electric current that charges the electric storage device 204 when the first portion of the enclosure 302 moves relative to the second portion of the enclosure 302. Accordingly, the controller 206 may determine that the tampering event has occurred in which the first portion of the enclosure 302 is moved relative to the second portion of the enclosure 302 to open the enclosure 302. Based on this determination, the controller 206 may generate the tampering output indicating that the tampering event has occurred.

As described above, the tampering event may occur while the product object 104 is in the off state, the tamper detection device 102 is not powered, and the controller 206 is inoperative. In this case, the electric current may be generated by the current generation system 202 when the tampering event occurs and the electric storage device 204 may be charged by the electric current at that time. As described above, after the tampering event has occurred, the product object 104 may be switched from the off state to the on state at the particular time and therefore the tamper detection device 102 is powered and the controller 206 becomes operative. After the controller 206 becomes operative, the controller 206 may determine that the electric storage device 204 is charged, and therefore determine that the tampering event has occurred while the product object 104 is in the off state prior to the particular time. Accordingly, the controller 206 may generate the tampering output indicating that the tampering event has occurred while the product object 104 is in the off state prior to the particular time. In some embodiments, the tampering output may include the particular time or the time at which the controller 206 determines that the tampering event has occurred as additional information.

At operation 506, subsequent to determining that the electric storage device 204 is charged, the controller 206 may discharge the electric storage device 204 to reset the electric storage device 204 for another tamper detection. As an example, for the electric storage device 204 that is implemented using the capacitor (e.g., the capacitor 402), the controller 206 may provide a control signal to a switch element (e.g., the FET 440) to close the switch element and connect the capacitor to the ground. When the capacitor is connected to the ground, the charge on the capacitor is drained. As a result, the capacitor may be discharged and reset for another tamper detection. As another example, for the electric storage device 204 that is implemented using the non-volatile memory (e.g., the EEPROM), the controller 206 may overwrite the value stored in the non-volatile memory with a default value (e.g., bit 0) to reset the non-volatile memory for another tamper detection.

Thus, as described above, based on the determination that the electric storage device 204 is charged, the controller 206 may determine that the tampering event has occurred. The controller 206 may then generate the tampering output indicating that the tampering event has occurred, and transmit the tampering output to the product object 104. In some embodiments, the tampering output being transmitted to the product object 104 may be subjected to cryptographic protection. To provide the cryptographic protection for the tampering output, at operation 510, the controller 206 may generate a cryptographic value based on the tampering output. In some embodiments, the controller 206 may generate the cryptographic value for the tampering output using cryptographic information provided to the tamper detection device 102 at the manufacture time.

In some embodiments, at the manufacture time, the tamper detection device 102 and the product object 104 may be associated with one another. For example, the tamper detection device 102 and the product object 104 may be coupled to one another and may be contained in the same enclosure 302. In addition, the tamper detection device 102 and the product object 104 may be configured to operate in a compatible manner with one another. In some embodiments, for the tamper detection device 102 and the product object 104 that are associated with one another, the tamper detection device 102 and the product object 104 may be provided with the cryptographic information associated with the tamper detection device 102 and/or the cryptographic information associated with both the tamper detection device 102 and the product object 104. In some embodiments, the tamper detection device 102 and the product object 104 may store the cryptographic information in their storage device and the cryptographic information may be accessible only via their secure cryptoprocessor.

To illustrate, the tamper detection device 102 and the product object 104 may each store a cryptographic key associated with the tamper detection device 102. For example, the tamper detection device 102 may store a private key of the tamper detection device 102 while the product object 104 may store a public key of the tamper detection device 102 that corresponds to the private key of the tamper detection device 102. Additionally or alternatively, the tamper detection device 102 and the product object 104 may store the same secret key that is provided only to the tamper detection device 102 and the product object 104. Thus, the secret key may be shared only between the tamper detection device 102 and the product object 104 and may be referred to herein as the secret key for simplification.

In some embodiments, the cryptographic information stored by the tamper detection device 102 and the cryptographic information stored by the product object 104 may also specify the same hash function (e.g., SHA-256, MD5, etc.). The tamper detection device 102 may use the hash function when generating a notification message that is transmitted to the product object 104, and the product object 104 may use the hash function when verifying a notification message that is received at the product object 104. The hash function being used by the tamper detection device 102 and the product object 104 may be referred to herein as the hash function for simplification. In some embodiments, the tamper detection device 102 and/or the product object 104 may store other types of cryptographic information in their storage device.

In some embodiments, the tamper detection device 102 and the product object 104 may use the cryptographic information stored in their storage device to cryptographically protect the communication between the tamper detection device 102 and the product object 104. For example, to transmit the tampering output to the product object 104, the tamper detection device 102 may generate a cryptographic value based on the tampering output using the cryptographic information stored by the tamper detection device 102. The cryptographic value generated based on the tampering output may be referred to herein as the cryptographic value of the tampering output or the cryptographic value associated with the tampering output.

As a first example, the controller 206 of the tamper detection device 102 may generate a hash value of the tampering output using the hash function. As described herein, the hash function may be used by both the tamper detection device 102 and the product object 104. The controller 206 may then encrypt the hash value of the tampering output using the private key of the tamper detection device 102. Thus, in this case, the cryptographic value of the tampering output may be the encrypted hash value of the tampering output, in which the encrypted hash value is generated using the hash function and the private key of the tamper detection device 102.

As a second example, the controller 206 of the tamper detection device 102 may combine the tampering output with the secret key that is shared only between the tamper detection device 102 and the product object 104. The controller 206 may then generate a hash value of the combination between the tampering output and the secret key using the hash function. Thus, in this case, the cryptographic value of the tampering output may be the hash value of the combination between tampering output and the secret key, in which the hash value is generated using the hash function and the secret key that is shared only between the tamper detection device 102 and the product object 104. Other implementations for generating the cryptographic value of the tampering output are also possible and contemplated.

In some embodiments, after the cryptographic value of the tampering output is generated, at operation 512, the controller 206 may generate a notification message including the tampering output in its original form and the cryptographic value of the tampering output. At operation 514, the controller 206 may transmit the notification message to the product object 104 via the connection 110. Thus, when determining that the electric storage device 204 is charged and therefore determining that the tampering event has occurred, the controller 206 may transmit the tampering output indicating that the tampering event has occurred together with the cryptographic value of the tampering output to the product object 104 in the notification message.

In some embodiments, if at operation 502, the controller 206 determines that the electric storage device 204 is not charged, the method 500 may proceed to operation 508. At operation 508, the controller 206 may generate a non-tampering output indicating that the tampering event has not occurred. In this case, because the electric storage device 204 is not charged, the controller 206 may determine that an electric current is not generated by the current generation system 202, and therefore determine that the first portion of the enclosure 302 is not moved relative to the second portion of the enclosure 302. Accordingly, the controller 206 may determine that the tampering event in which the first portion of the enclosure 302 is moved relative to the second portion of the enclosure 302 to open the enclosure 302 has not occurred. Based on this determination, the controller 206 may generate the non-tampering output indicating that the tampering event has not occurred.

As described above, the determination that the electric storage device 204 is not charged may be performed by the controller 206 within the time window (e.g., 2 minutes) since the product object 104 is switched from the off state to the on state and powers the tamper detection device 102 at the particular time. In this case, the controller 206 may determine that the electric storage device 204 is not charged, and therefore determine that the tampering event has not occurred when the product object 104 is in the off state prior to the particular time. Accordingly, the controller 206 may generate the non-tampering output indicating that the tampering event has not occurred when the product object 104 is in the off state prior to the particular time. In some embodiments, the non-tampering output may include the particular time or the time at which the controller 206 determines that the tampering event has not occurred as additional information.

In some embodiments, after the non-tampering output is generated, the controller 206 may transmit the non-tampering output to the product object 104. Similar to the tampering output being transmitted to the product object 104, the non-tampering output being transmitted to the product object 104 may also be subjected to cryptographic protection. For example, to provide the cryptographic protection for the non-tampering output, at operation 510, the controller 206 may generate a cryptographic value based on the non-tampering output. The cryptographic value generated based on the non-tampering output may be referred to herein as the cryptographic value of the non-tampering output or the cryptographic value associated with the non-tampering output. In some embodiments, the controller 206 may generate the cryptographic value of the non-tampering output in a manner similar to the manner in which the controller 206 generates the cryptographic value of the tampering output as described above. This description therefore is not repeated for brevity.

In some embodiments, after the cryptographic value of the non-tampering output is generated, at operation 512, the controller 206 may generate a notification message including the non-tampering output in its original form and the cryptographic value of the non-tampering output. At operation 514, the controller 206 may transmit the notification message to the product object 104 via the connection 110. Thus, when determining that the electric storage device 204 is not charged and therefore determining that the tampering event has not occurred, the controller 206 may transmit the non-tampering output indicating that the tampering event has not occurred together with the cryptographic value of the non-tampering output to the product object 104 in the notification message.

Thus, as described above, if the controller 206 determines that the electric storage device 204 is charged and therefore determines that the tampering event has occurred, the controller 206 may generate the tampering output indicating that the tampering event has occurred, and transmit the notification message including the tampering output and the cryptographic value of the tampering output to the product object 104. On the other hand, if the controller 206 determines that the electric storage device 204 is not charged and therefore determines that the tampering event has not occurred, the controller 206 may generate the non-tampering output indicating that the tampering event has not occurred, and transmit the notification message including the non-tampering output and the cryptographic value of the non-tampering output to the product object 104. As described above, the determination of whether the electric storage device 204 is charged may be performed by the controller 206 within the time window (e.g., 2 minutes) since the product object 104 is switched from the off state to the on state and powers the tamper detection device 102 at the particular time. Based on this determination, the controller 206 of the tamper detection device 102 may determine whether the tampering event has occurred while the product object 104 is in the off state prior to the particular time, and transmit the notification message including the tampering output or the non-tampering output to the product object 104 accordingly.

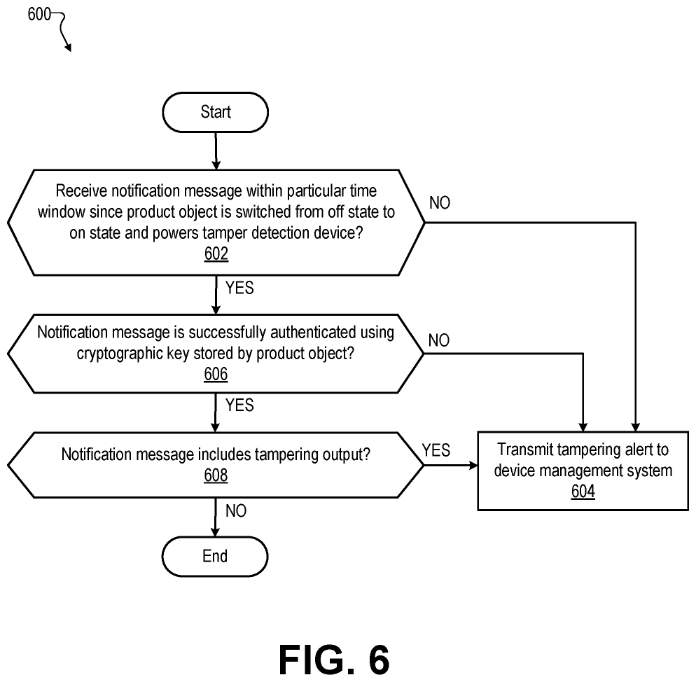

FIG. 6 illustrates an example method 600 for performing tamper detection. While FIG. 6 shows illustrative operations according to one embodiment, other embodiments may omit, add to, reorder, and/or modify any of the operations shown in FIG. 6. In some examples, multiple operations shown in FIG. 6 or described in relation to FIG. 6 may be performed concurrently (e.g., in parallel) with one another, rather than being performed sequentially as illustrated and/or described. One or more of the operations shown in FIG. 6 may be performed by the product object 104 and/or any implementation thereof. For example, the operations in FIG. 6 may be performed by the product object 104 when the product object 104 is switched from the off state to the on state at a particular time.

At operation 602, the product object 104 may determine whether the product object 104 receives a notification message within a particular time window (e.g., 5 minutes) since the product object 104 is switched from the off state to the on state and powers the tamper detection device 102 at the particular time. As described above, within the time window (e.g., 2 minutes) since the product object 104 is switched from the off state to the on state and powers the tamper detection device 102 at the particular time, the controller 206 of the tamper detection device 102 may determine whether the tampering event has occurred while the product object 104 is in the off state prior to the particular time, and transmit the tampering output or the non-tampering output to the product object 104 in the notification message. Accordingly, the product object 104 may expect to receive the notification message including the tampering output or the non-tampering output from the tamper detection device 102 within the particular time window (e.g., 5 minutes) since the particular time.

If at operation 602, the product object 104 determines that the product object 104 does not receive a notification message within the particular time window (e.g., 5 minutes) since the particular time, the product object 104 may determine that no tampering output and no non-tampering output is received from the tamper detection device 102 within the particular time window since the product object 104 is switched from the off state to the on state and powers the tamper detection device 102 at the particular time. Accordingly, the product object 104 may determine that the tamper detection device 102 does not communicate with the product object 104 as expected, and therefore determine that the tamper detection device 102 may be damaged or may be removed. In this case, the method 600 may proceed to operation 604. At operation 604, the product object 104 may generate a tampering alert indicating that the tampering event has occurred, and transmit the tampering alert to the device management system 106 via a secured communication channel such as the connection 130. Thus, in this case, the product object 104 may determine that the tampering event has occurred because the product object 104 does not receive the detection output from the tamper detection device 102 as expected.

If at operation 602, the product object 104 determines that the product object 104 receives a notification message within the particular time window (e.g., 5 minutes) since the particular time, the method 600 may proceed to operation 606. At operation 606, the product object 104 may authenticate the notification message using the cryptographic information stored by the product object 104 and determine whether the notification message is successfully authenticated. For example, the product object 104 may authenticate the notification message using the cryptographic key stored by the product object 104 and determine whether the notification message is successfully authenticated using the cryptographic key. As described herein, the product object 104 may store the cryptographic key associated with the tamper detection device 102 in its storage device. For example, the product object 104 may store the public key of the tamper detection device 102 and/or the secret key that is shared only between the tamper detection device 102 and the product object 104. In some embodiments, to authenticate the notification message using the cryptographic key stored by the product object 104, the product object 104 may use the cryptographic key to decrypt the cryptographic value in the notification message or to re-generate the cryptographic value in the notification message.

As an example, in the first example described above in FIG. 5, the tamper detection device 102 may generate the hash value of the detection output (e.g., the tampering output or the non-tampering output) using the hash function, and encrypt the hash value of the detection output using the private key of the tamper detection device 102. In this case, the encrypted hash value of the detection output may be considered the cryptographic value of the detection output. As described in the first example, the tamper detection device 102 may include the detection output and the encrypted hash value of the detection output in the notification message, and transmit the notification message to the product object 104.

Accordingly, when receiving a notification message, the product object 104 may extract the encrypted hash value from the notification message, and decrypt the encrypted hash value using the public key of the tamper detection device 102. In some embodiments, if the encrypted hash value in the notification message is decryptable using the public key of the tamper detection device 102, the product object 104 may determine that the notification message is generated by the tamper detection device 102 associated with the product object 104, and therefore determine that the authenticity of the notification message is successfully verified. On the other hand, if the encrypted hash value in the notification message is not decryptable using the public key of the tamper detection device 102, the product object 104 may determine that the notification message is generated by a different device that is not the tamper detection device 102 associated with the product object 104, and therefore determine that the authenticity of the notification message is unsuccessfully verified. In this case, the product object 104 may determine that the tamper detection device 102 may be replaced with a different device, and therefore determine that the tampering event has occurred.

In some embodiments, if the encrypted hash value in the notification message is decryptable using the public key of the tamper detection device 102, the product object 104 may obtain the decrypted hash value as a result of the decryption. In addition to decrypting the encrypted hash value in the notification message, the product object 104 may also extract the detection output from the notification message, and compute a hash value of the detection output using the hash function. In some embodiments, the product object 104 may compare the computed hash value that is generated from the detection output in the notification message and the decrypted hash value that is decrypted from the encrypted hash value in the notification message.

In some embodiments, if the computed hash value matches the decrypted hash value, the product object 104 may determine that the detection output in the notification message matches the detection output being used to generate the encrypted hash value in the notification message. Accordingly, the product object 104 may determine that the detection output in the notification message is not modified, and therefore determine that the integrity of the notification message is successfully verified. On the other hand, if the computed hash value does not match the decrypted hash value, the product object 104 may determine that the detection output in the notification message does not match the detection output being used to generate the encrypted hash value in the notification message. Accordingly, the product object 104 may determine that the detection output in the notification message is modified, and therefore determine that the integrity of the notification message is unsuccessfully verified. In this case, the product object 104 may determine that the communication of the notification message between the tamper detection device 102 and the product object 104 may be intercepted, and therefore determine that the tampering event has occurred.

As another example, in the second example described above in FIG. 5, the tamper detection device 102 may combine the detection output (e.g., the tampering output or the non-tampering output) and the secret key that is shared only between the tamper detection device 102 and the product object 104, and generate the hash value of the combination between the detection output and the secret key using the hash function. In this case, the hash value of the combination between the detection output and the secret key may be considered the cryptographic value of the detection output. As described in the second example, the tamper detection device 102 may include the detection output and the hash value of the combination between the detection output and the secret key in the notification message, and transmit the notification message to the product object 104.

Accordingly, when receiving a notification message, the product object 104 may extract the hash value and the detection output from the notification message. The product object 104 may then combine the detection output in the notification message and the secret key that is shared only between the tamper detection device 102 and the product object 104, and compute the hash value of the combination between the detection output and the secret key using the hash function. In some embodiments, the product object 104 may compare the computed hash value that is generated using the detection output in the notification message and the hash value extracted from the notification message.

In some embodiments, if the computed hash value matches the extracted hash value, the product object 104 may determine that the hash value in the notification message is generated using the secret key that is shared only between the tamper detection device 102 and the product object 104. Accordingly, the product object 104 may determine that the notification message is generated by the tamper detection device 102 associated with the product object 104, and therefore determine that the authenticity of the notification message is successfully verified. In addition, because the computed hash value matches the extracted hash value, the product object 104 may determine that the detection output in the notification message matches the detection output being used to generate the hash value in the notification message. Accordingly, the product object 104 may determine that the detection output in the notification message is not modified, and therefore determine that the integrity of the notification message is successfully verified. Thus, in this case, the product object 104 may determine that both the authenticity of the notification message and the integrity of the notification message are successfully verified.

On the other hand, if the computed hash value does not match the extracted hash value, the product object 104 may determine that the hash value in the notification message is generated using a different key and not the secret key that is shared only between the tamper detection device 102 and the product object 104, or the detection output in the notification message does not match the detection output being used to generate the hash value in the notification message, or both. Based on such determination, the product object 104 may determine that the notification message is generated by a different device that is not the tamper detection device 102 associated with the product object 104 and/or the detection output in the notification message is modified. Accordingly, the product object 104 may determine that at least one of the authenticity of the notification message and the integrity of the notification message is unsuccessfully verified. In this case, the product object 104 may determine that the tamper detection device 102 may be replaced with a different device and/or the communication of the notification message between the tamper detection device 102 and the product object 104 may be intercepted. As a result, the product object 104 may determine that the tampering event has occurred.

Thus, based on the cryptographic value in the notification message and the cryptographic key stored by the product object 104, the product object 104 may determine whether the notification message is generated by the tamper detection device 102 associated with the product object 104 and also determine whether the detection output in the notification message is modified, thereby verifying the authenticity and the integrity of the notification message.

As described above, the product object 104 may determine that the notification message is generated by a different device and not the tamper detection device 102 associated with the product object 104 and/or determine that the detection output in the notification message is modified. In this case, the product object 104 may determine that the authenticity and/or the integrity of the notification message is unsuccessfully verified, and therefore determine that the notification message is unsuccessfully authenticated using the cryptographic key stored by the product object 104. In some embodiments, in response to determining that the notification message is unsuccessfully authenticated, the product object 104 may determine that the tampering event has occurred and the method 600 may proceed to operation 604. At operation 604, the product object 104 may generate the tampering alert indicating that the tampering event has occurred, and transmit the tampering alert to the device management system 106 via the secured communication channel such as the connection 130. Thus, in this case, the product object 104 may determine that the tampering event has occurred because the notification message received at the product object 104 is generated by a different device and not the tamper detection device 102 associated with the product object 104 and/or because the communication of the notification message between the tamper detection device 102 and the product object 104 is intercepted and the detection output in the notification message is modified.

Alternatively, the product object 104 may determine that the notification message is generated by the tamper detection device 102 associated with the product object 104 and also determine that the detection output in the notification message is not modified. In this case, the product object 104 may determine that the authenticity and the integrity of the notification message are both successfully verified, and therefore determine that the notification message is successfully authenticated using the cryptographic key stored by the product object 104. In some embodiments, in response to determining that the notification message is successfully authenticated, the method 600 may proceed to operation 608.

At operation 608, the product object 104 may determine whether the notification message includes a tampering output. If the detection output in the notification message is the tampering output, the product object 104 may determine that the tampering event has occurred and the method 600 may proceed to operation 604. At operation 604, the product object 104 may generate the tampering alert indicating that the tampering event has occurred, and transmit the tampering alert to the device management system 106 via the secured communication channel such as the connection 130. Thus, in this case, the product object 104 may determine that the tampering event has occurred because the product object 104 receives the tampering output indicating that the tampering event has occurred from the tamper detection device 102 associated with the product object 104. On the other hand, if the detection output in the notification message is the non-tampering output, the product object 104 may determine that the tampering event has not occurred. In this case, the product object 104 may not transmit the tampering alert to the device management system 106.

Thus, as described above, the tamper detection device 102 may determine whether the tampering event has occurred based on the charge condition of the electric storage device 204, and transmit the detection output (e.g., the tampering output or the non-tampering output) to the product object 104 in the notification message. The product object 104 may determine whether the tampering event has occurred based on the particular time window in which the notification message is expected, the verification of the notification message, and/or the detection result included in the notification message. As described above, in response to determining that the tampering event has occurred, the product object 104 may generate the tampering alert indicating that the tampering event has occurred, and transmit the tampering alert to the device management system 106 via the secured communication channel.

In some embodiments, when receiving the tampering alert from the product object 104 via the secured communication channel, the device management system 106 may update the tamper history of the product object 104 to include the tampering event. The device management system 106 may also include in the tamper history of the product object 104 additional information associated with the tampering event such as the particular time prior to which the tampering event has occurred, the time at which the tamper detection device 102 or the product object 104 determines that the tampering event has occurred, the reason that results in the tamper detection device 102 or the product object 104 determines that the tampering event has occurred (e.g., the product object 104 does not receive the notification message as expected, the notification message is unsuccessfully authenticated, the notification message is successfully authenticated and includes the tampering output, etc.), etc. Thus, the tamper history of the product object 104 may be updated to include the tampering event and the corresponding information of the tampering event without any human interaction.

In some embodiments, when receiving the tampering alert from the product object 104 via the secured communication channel, the device management system 106 may also provide an alert notification to a relevant user (e.g., a device operator, a system administrator, etc.). The alert notification may notify the relevant user that the tampering event has occurred to the product object 104 and/or to the tamper detection device 102 associated with the product object 104 that are contained in the enclosure 302. Accordingly, the relevant user may be informed of the tampering event that occurs to the product object 104 and/or to the tamper detection device 102 being contained in the enclosure 302 without the need to be at the location where the enclosure 302 is placed to perform in-person inspection.

Thus, as described above, the tamper detection device 102 and the product object 104 may determine whether the tampering event has occurred while the product object 104 is in the off state with the tamper detection device 102 being unpowered and the controller 206 of the tamper detection device 102 being inoperative. However, it should be understood that the tamper detection device 102 and the product object 104 may operate in similar manner to determine whether the tampering event has occurred while the product object 104 is in the on state with the tamper detection device 102 being powered and the controller 206 of the tamper detection device 102 being operative.

For example, while the product object 104 is in the on state and the controller 206 is operative, the controller 206 may perform the method 500 in FIG. 5 at a predefined interval (e.g., every 3 minutes) to periodically determine whether the electric storage device 204 is charged and therefore determine whether the tampering event has occurred. The controller 206 may then transmit the detection output indicating whether the tampering event has occurred to the product object 104 in the notification message as described herein with reference to FIG. 5. Similarly, the product object 104 may perform the method 600 in FIG. 6 at a predefined interval (e.g., every 4 minutes) to evaluate the timeliness in receiving the notification message at the product object 104 and/or process the notification message received at the product object 104 to determine whether the tampering event has occurred. In this case, at operation 602 of the method 600, instead of determining whether the product object 104 receives a notification message within the particular time window since the product object 104 is switched from the off state to the on state and powers the tamper detection device 102 at the particular time, the product object 104 may determine whether the product object 104 receives a notification message within the particular time window since the product object 104 receives the most recent notification message. Other operations of the method 600 may be performed in the same manner described herein with reference to FIG. 6.

In some embodiments, instead of relying on the charge condition of the electric storage device 204 to determine whether the tampering event has occurred while the product object 104 is in the on state and the controller 206 is operative as described above, the controller 206 of the tamper detection device 102 may use other techniques to determine whether the tampering event has occurred while the product object 104 is in the on state and the controller 206 is operative.

As an example, the tamper detection device 102 may include the magnet 310 attached to the first portion of the enclosure 302 as described herein, and also include a Hall sensor positioned relative to the magnet 310. Due to the position of the Hall sensor relative to the magnet 310, the Hall sensor may be able to detect the presence of the magnetic field associated with the magnet 310 when the enclosure 302 is closed and the first portion of the enclosure 302 is in the close position, but may not be able to detect the presence of the magnetic field associated with the magnet 310 when the enclosure 302 is opened and the first portion of the enclosure 302 is no longer in the close position.

In some embodiments, the controller 206 may monitor a sensor output of the Hall sensor. For example, the controller 206 may obtain the sensor output of the Hall sensor at a predefined interval (e.g., every 4 minutes). If the sensor output of the Hall sensor indicates that the magnetic field associated with the magnet 310 is detected by the Hall sensor, the controller 206 may determine that the first portion of the enclosure 302 is in the close position and the enclosure 302 is closed. Accordingly, the controller 206 may determine that the enclosure 302 is not opened, and therefore determine that the tampering event has not occurred. On the other hand, if the sensor output of the Hall sensor indicates that the magnetic field associated with the magnet 310 is not detected by the Hall sensor, the controller 206 may determine that the first portion of the enclosure 302 is no longer in the close position. Accordingly, the controller 206 may determine that the enclosure 302 is opened, and therefore determine that the tampering event has occurred. Thus, by monitoring the sensor output of the Hall sensor, the controller 206 may determine whether the tampering event has occurred while the product object 104 is in the on state and the controller 206 is operative.

As another example, the tamper detection device 102 may include an optical target positioned on the first portion of the enclosure 302 and also include an optical sensor positioned relative to the optical target. Due to the position of the optical sensor relative to the optical target, the optical sensor may be able to detect the presence of the optical target when the enclosure 302 is closed and the first portion of the enclosure 302 is in the close position, but may not be able to detect the presence of the optical target when the enclosure 302 is opened and the first portion of the enclosure 302 is no longer in the close position.

In some embodiments, the controller 206 may monitor a sensor output of the optical sensor. For example, the controller 206 may obtain the sensor output of the optical sensor at a predefined interval (e.g., every 4 minutes). If the sensor output of the optical sensor indicates that the optical target is detected by the optical sensor, the controller 206 may determine that the first portion of the enclosure 302 is in the close position and the enclosure 302 is closed. Accordingly, the controller 206 may determine that the enclosure 302 is not opened, and therefore determine that the tampering event has not occurred. On the other hand, if the sensor output of the optical sensor indicates that the optical target is not detected by the optical sensor, the controller 206 may determine that the first portion of the enclosure 302 is no longer in the close position. Accordingly, the controller 206 may determine that the enclosure 302 is opened, and therefore determine that the tampering event has occurred. Thus, by monitoring the sensor output of the optical sensor, the controller 206 may determine whether the tampering event has occurred while the product object 104 is in the on state and the controller 206 is operative. Other implementations for determining whether the tampering event has occurred while the product object 104 is in the on state and the controller 206 is operative are also possible and contemplated.

Thus, as described herein, the tamper detection device 102 and the product object 104 are capable of determining that the tampering event has occurred in case the tampering event occurs while the product object 104 is in the off state and therefore the tamper detection device 102 is not powered and the controller 206 is inoperative. The tamper detection device 102 and the product object 104 are also capable of determining that the tampering event has occurred in case the tampering event occurs while the product object 104 is in the on state and therefore the tamper detection device 102 is powered and the controller 206 is operative. Accordingly, the tamper detection device 102 and the product object 104 are capable of detecting the tampering event in both situations, thereby providing a comprehensive tamper detection for the product object 104 and the tamper detection device 102. In addition, as the tamper detection device 102 and the product object 104 are capable of detecting the tampering event in both situations, an attempt to gain physical access to the tamper detection device 102 and alter, damage, or remove the tamper detection device 102 to bypass the tamper detection device 102 in future access can be detected, regardless of whether the product object 104 is in the on state or in the off state and regardless of whether the tamper detection device 102 is powered or not powered when that attempt occurs.

The foregoing description has been presented for the purposes of illustration and description. It is not intended to be exhaustive or to limit the specification to the precise form disclosed. Many modifications and variations are possible in light of the above teaching. It is intended that the scope of the disclosure is not limited by this detailed description and the modifications and variations that fall within the spirit and scope of the appended claims are included. As will be understood by those familiar with the art, the specification may be embodied in other specific forms without departing from the spirit or essential characteristics thereof.

In particular and with regard to various functions performed by the above-described components, devices, circuits, systems, and/or the like, the terms (including a reference to a “means”) used to describe such components are intended to correspond, unless otherwise indicated, to any component which performs the specified function of the described component (e.g., a functional equivalent), even if such component may not be structurally equivalent to the described structure, which illustrates exemplary aspects of the present disclosure. In this regard, it should also be recognized that the present disclosure includes a system as well as a computer-readable medium having computer-executable instructions for performing the acts and/or events of various methods described herein.

In addition, while a particular feature of the present disclosure may have been disclosed with respect to only one of several implementations, such feature may be combined with one or more other features of the other implementations as may be desired and advantageous for a given application. Furthermore, to the extent that the terms “includes,” and “including” and variants thereof are used in either the detailed description or the claims, these terms are intended to be inclusive in a manner similar to the term “comprising.”

In this application, the word “exemplary” and “example” are used to mean serving as an example, instance, or illustration. Any aspect or design described herein as “exemplary” or “example” is not necessarily to be construed as preferred or advantageous over other aspects or designs. Instead, the use of the word “exemplary” and “example” is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from a computer-readable device, carrier, or media. For example, computer readable media may include, but are not limited to, magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.).

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A tamper detection device comprising:
a current generation system positioned relative to a first portion of an enclosure and a second portion of the enclosure, wherein the enclosure contains a product object and the tamper detection device communicatively coupled to the product object, the tamper detection device being configured to be powered by the product object;
an electric storage device coupled to the current generation system to be charged by an electric current generated by the current generation system, wherein the electric current is generated when the first portion of the enclosure moves relative to the second portion of the enclosure, and the electric current is generatable when the product object is in an off state and the tamper detection device is not powered; and
a controller coupled to the electric storage device and configured to:
determine, within a time window since a particular time at which the product object is switched from the off state to an on state and powers the tamper detection device, that the electric storage device is charged;
generate, in response to determining that the electric storage device is charged, a tampering output indicating that a tampering event has occurred when the product object is in the off state prior to the particular time; and
transmit the tampering output to the product object.

2. The tamper detection device of claim 1, wherein:
the tamper detection device does not include a separate power source that supplies power to the controller of the tamper detection device;
when the product object is in the on state, the controller is operative; and
when the product object is in the off state, the controller is inoperative.

3. The tamper detection device of claim 1, wherein:
the tampering event includes the first portion of the enclosure being moved relative to the second portion of the enclosure to open the enclosure.

4. The tamper detection device of claim 1, wherein the current generation system includes:
a magnet attached to the first portion of the enclosure; and
a wire coil coupled to the electric storage device and placed at a fixed position relative to the second portion of the enclosure,
wherein the electric storage device is charged by the electric current generated in the wire coil when the movement of the first portion of the enclosure relative to the second portion of the enclosure causes a movement of the magnet relative to the wire coil, the electric current is an induced current.

5. The tamper detection device of claim 1, wherein the current generation system includes:
a piezoelectric sensor coupled to the electric storage device and being in physical contact with the first portion of the enclosure when the enclosure is closed,
wherein the electric storage device is charged by the electric current generated in the piezoelectric sensor when the movement of the first portion of the enclosure relative to the second portion of the enclosure causes a deformation of the piezoelectric sensor.

6. The tamper detection device of claim 1, wherein:
the movement of the first portion of the enclosure relative to the second portion of the enclosure when the enclosure is opened occurs within a time duration that satisfies a time duration threshold.

7. The tamper detection device of claim 1, wherein to determine that the electric storage device is charged, the controller is configured to:
determine that a voltage of the electric storage device satisfies a voltage threshold; and
determine, in response to determining that the voltage of the electric storage device satisfies the voltage threshold, that the electric storage device is charged.

8. The tamper detection device of claim 1, wherein the controller is configured to:
discharge, subsequent to determining that the electric storage device is charged, the electric storage device to reset the electric storage device.

9. The tamper detection device of claim 1, wherein to transmit the tampering output to the product object, the controller is configured to:
generate a cryptographic value based on the tampering output;
generate a notification message including the tampering output and the cryptographic value; and
transmit the notification message to the product object.

10. A system comprising the tamper detection device of claim 1 and the product object, wherein the product object is configured to:
receive a notification message from the tamper detection device;
authenticate the notification message using a cryptographic key stored by the product object;
determine that the notification message is unsuccessfully authenticated using the cryptographic key stored by the product object; and
transmit, in response to determining that the notification message is unsuccessfully authenticated using the cryptographic key stored by the product object, a tampering alert to a device management system via a secured communication channel, the tampering alert indicating that the tampering event has occurred.

11. A system comprising the tamper detection device of claim 1 and the product object, wherein the product object is configured to:
receive a notification message from the tamper detection device;
authenticate the notification message using a cryptographic key stored by the product object;
determine that the notification message is successfully authenticated using the cryptographic key stored by the product object;
determine that the notification message includes the tampering output; and
transmit, in response to determining that the notification message is successfully authenticated and includes the tampering output, a tampering alert to a device management system via a secured communication channel, the tampering alert indicating that the tampering event has occurred.

12. The tamper detection device of claim 1, wherein the controller is configured to:
determine, within the time window since a different time at which the product object is switched from the off state to the on state and powers the tamper detection device, that the electric storage device is not charged;
generate, in response to determining that the electric storage device is not charged, a non-tampering output indicating that the tampering event has not occurred when the product object is in the off state prior to the different time; and
transmit the non-tampering output to the product object.

13. A system comprising the tamper detection device of claim 1 and the product object, wherein the product object is configured to:
determine that no tampering output and no non-tampering output is received from the tamper detection device within a particular time window since the product object is switched from the off state to the on state and powers the tamper detection device; and
transmit, in response to determining that no tampering output and no non-tampering output is received from the tamper detection device within the particular time window since the product object is switched from the off state to the on state and powers the tamper detection device, a tampering alert to a device management system via a secured communication channel, the tampering alert indicating that the tampering event has occurred.

14. The tamper detection device of claim 1, wherein:
the electric storage device, the controller, and one or more additional elements of the tamper detection device is incorporated into an integrated circuit chip.

15. The tamper detection device of claim 1, wherein:
the electric storage device, the controller, and one or more additional elements of the tamper detection device is integrated as part of the product object.

16. A method executed by a controller of a tamper detection device, the method comprises:
determining, within a time window since a particular time at which a product object is switched from an off state to an on state and powers the tamper detection device, that an electric storage device of the tamper detection device is charged, wherein
the tamper detection device includes a current generation system positioned relative to a first portion of an enclosure and a second portion of the enclosure, the enclosure contains the product object and the tamper detection device communicatively coupled to the product object, the tamper detection device is configured to be powered by the product object, and
the tamper detection device includes the electric storage device coupled to the current generation system to be charged by an electric current generated by the current generation system, the electric current is generated when the first portion of the enclosure moves relative to the second portion of the enclosure, the electric current is generatable when the product object is in the off state and the tamper detection device is not powered;
generating, in response to determining that the electric storage device is charged, a tampering output indicating that a tampering event has occurred when the product object is in the off state prior to the particular time; and
transmitting the tampering output to the product object.

17. The method of claim 16, wherein:
the tamper detection device does not include a separate power source that supplies power to the controller of the tamper detection device;
when the product object is in the on state, the controller is operative; and
when the product object is in the off state, the controller is inoperative.

18. The method of claim 16, further comprising:
discharging, subsequent to determining that the electric storage device is charged, the electric storage device to reset the electric storage device.

19. The method of claim 16, wherein transmitting the tampering output to the product object includes:
generating a cryptographic value based on the tampering output;
generating a notification message including the tampering output and the cryptographic value; and
transmitting the notification message to the product object.

20. A tamper detection device comprising:
a magnet attached to a first portion of an enclosure, wherein the enclosure contains a product object and the tamper detection device communicatively coupled to the product object, the tamper detection device is configured to be powered by the product object;
a circuit board attached to a second portion of the enclosure, wherein the circuit board includes a controller, a wire coil, and a capacitor coupled to the wire coil to be charged by an induced current generated in the wire coil when a movement of the first portion of the enclosure relative to the second portion of the enclosure causes a movement of the magnet relative to the wire coil, the induced current is generatable in the wire coil when the product object is in an off state and the tamper detection device is not powered; and
wherein the controller is coupled to the capacitor and configured to:
determine, within a time window since a particular time at which the product object is switched from the off state to an on state and powers the tamper detection device, that the capacitor is charged;
generate, in response to determining that the capacitor is charged, a tampering output indicating that a tampering event has occurred when the product object is in the off state prior to the particular time; and
transmit the tampering output to the product object.
